(19) United States
(12) Patent Application Publication
(10) Pub. No.: US 2012/0180592 A1
(43) Pub. Date: Jul. 19, 2012

(54) ELECTRICAL MACHINE APPARATUS AND ROBOT

(75) Inventor: Kesatoshi TAKEUCHI, Shiojiri (JP)

(73) Assignee: SEIKO EPSON CORPORATION, Tokyo (JP)

(21) Appl. No.: 13/352,672

(22) Filed: Jan. 18, 2012

(30) Foreign Application Priority Data
Jan. 19, 2011 (JP) 2011-008761

(51) Int. Cl. B25J 18/00; G05B 1/06; H02K 11/00

(52) U.S. Cl. 74/490.03; 310/68 B; 318/653; 318/634; 901/46; 901/23

(57) ABSTRACT

An electrical machine apparatus includes an electromagnetic coil, a rotor magnet, n (n is an integer not less than 2) magnetic sensors to detect an electric angle of the rotor magnet, and a position detection part to detect a position of the rotor magnet by using outputs of the magnetic sensors. Each of the magnetic sensors generates a sensor output signal having a curved line waveform and a period of electric angle 2π of the electrical machine apparatus. The respective n magnetic sensors are arranged to generate the sensor output signals with a phase difference other than an integer times π in electric angle. The position detection part calculates a movement amount of the rotor magnet from a starting point as a position before movement by using the sensor output signals of the n magnetic sensors.

### BACKGROUND

1. Technical Field

The present invention relates to rotational position control of an electric motor.

2. Related Art

An electrical machine apparatus (electric motor, generator) to control driving by using an output of an encoder is known (for example, JP-A-2010-207019 (patent document 1)).

However, since the encoder is externally attached to the electric motor, there is a disadvantage in miniaturization of the whole motor system and in that a driving load of the encoder is required. Besides, an absolute type encoder capable of detecting an absolute position is expensive.

### SUMMARY

An advantage of some aspects of the invention is to detect a movement amount and a position of an electrical machine apparatus, such as an electric motor, by a simple method.

### Application Example 1

This application example of the invention is directed to an electrical machine apparatus including an electromagnetic coil, a rotor magnet, n (n is an integer not less than 2) magnetic sensors to detect an electric angle of the rotor magnet, and a position detection part to detect a position of the rotor magnet by using outputs of the magnetic sensors. Each of the magnetic sensors generates a sensor output signal having a curved line waveform and a period of electric angle 2π of the electrical machine apparatus. The respective n magnetic sensors are arranged to generate the sensor output signals with a phase difference other than an integer times π in electric angle. The position detection part calculates a movement amount of the rotor magnet from a starting point as a position before movement by using the sensor output signals of the n magnetic sensors.

According to this application example, the movement amount of the rotor magnet can be easily calculated.

### Application Example 2

This application example of the invention is directed to the electrical machine apparatus of the above application example, wherein the magnetic sensors output an amount of magnetic flux density from the rotor magnet as the analog sensor signals.

### Application Example 3

This application example of the invention is directed to the electrical machine apparatus of Application Example 1 or 2, wherein the position detection part counts a number m (m is an integer) of periods occurring in the sensor output signal of the magnetic sensor by the movement of the rotor magnet from the starting point, and calculates the movement amount of the rotor magnet by using the number m of periods, the starting point, and a magnitude of the sensor output signal after the movement.

According to this application example, the movement amount of the rotor magnet can be easily calculated by using the number m of periods and the magnitude of the sensor output signal before and after the movement.

### Application Example 4

This application example of the invention is directed to the electrical machine apparatus of Application Example 3, wherein the position detection part calculates an offset θoffset as a movement amount of the rotor magnet from the starting point to a first change of the number m of periods by using a magnitude of the sensor output signal at the starting point, calculates a first movement amount mθo of the rotor magnet based on the number m of periods, calculates a second movement amount Δθ of the rotor magnet after passage of the number m of periods from the magnitude of the sensor output signal after the movement, and calculates the movement amount of the rotor magnet from the starting point by using a value (mθo+Δθ) obtained by adding the first movement amount mθo and the second movement amount Δθ and the offset θoffset.

According to this application example, the movement amount of the rotor magnet can be easily calculated by adding the first movement amount dependent on the number m of periods and the second movement amount as the movement amount in each period.

### Application Example 5

This application example of the invention is directed to the electrical machine apparatus of Application Example 4, wherein the position detection part converts the sensor output signal into a triangular wave signal, and calculates the second movement amount Δθ of the rotor magnet after passage of the number m of periods by using a value of the triangular wave signal.

According to this application example, even when the sensor output signal is saturated, the second movement amount Δθ can be easily calculated.

### Application Example 6

This application example of the invention is directed to the electrical machine apparatus of Application Example 4, wherein the position detection part converts the sensor output signal into a sine wave signal, and calculates the second movement amount Δθ of the rotor magnet after passage of the number m of periods by using a value of the sine wave signal.

According to this application example, even when the sensor output signal is saturated, the second movement amount Δθ can be easily calculated.

### Application Example 7

This application example of the invention is directed to the electrical machine apparatus of any of Application Examples 1 to 6, wherein one magnetic sensor of the plural magnetic sensors outputs an intermediate value between a minimum value and a maximum value of the sensor output signal at the starting point.

According to this application example, the offset θoffset at the starting point can be made zero.

### Application Example 8

This application example of the invention is directed to the electrical machine apparatus of any of Application Examples 1 to 7, wherein the number n of the magnetic sensors is 2, and the magnetic sensors are arranged to generate the output signals with a phase difference of π/2 in electric angle.

According to this application example, when the sensor output signal of one of the magnetic sensors is a maximum value or a minimum value, the other of the magnetic sensors outputs an intermediate value between the minimum value and the maximum value, and therefore, the second movement amount Δθ can be easily calculated.

### Application Example 9

This application example of the invention is directed to the electrical machine apparatus of any of Application Examples 1 to 8, wherein the magnetic sensors have temperature compensation functions.

According to this application example, an influence of a temperature of the electrical machine apparatus on the sensor signal of the magnetic sensor can be suppressed.

### Application Example 10

This application example of the invention is directed to the electrical machine apparatus of any of Application Examples 1 to 9, wherein the electrical machine apparatus is the apparatus that drives a driving target member including a start point sensor to detect a start point, and the position detection part calculates a movement amount of the rotor magnet from the start point by using the sensor output signals from the n magnetic sensors.

According to this application example, the movement amount of the driving target member from the start point, that is, an absolute position of the driving target member can be easily obtained.

### Application Example 11

This application example of the invention is directed to a robot including a base part, a moving part, a start point sensor to generate a start point signal when the base part and the moving part are located at a previously determined position, and an electrical machine apparatus that is disposed at a joint part between the base part and the moving part and moves the moving part relatively to the base part. The electrical machine apparatus is the electrical machine apparatus according to any of Application Examples 1 to 10.

The invention can be realized in various modes, and can be realized in various modes such as, for example, an electrical machine apparatus, a robot using the electrical machine apparatus, and a robot arm.

### BRIEF DESCRIPTION OF THE DRAWINGS

The invention will be described with reference to the accompanying drawings, wherein like numbers reference like elements.

FIGS. 1A to 1C are explanatory views showing a structure of a robot arm of a first embodiment.

FIG. 2 is an explanatory view showing a structure of a motor system of a robot.

FIG. 3 is an explanatory view for explaining a motor in detail.

FIG. 4A is an explanatory view showing a structure of a start point sensor when the robot arm is seen in the z direction.

FIG. 4B is an explanatory view when the robot arm is seen in the y direction at a start point position.

FIG. 4C is an explanatory view when the robot arm is seen in the y direction at a position separate from the start point.

FIG. 5 is an explanatory view showing a structure of a present point detection circuit 700.

FIG. 6A shows a pulse generation circuit 710.

FIG. 6B shows a pulse generation circuit 715.

FIG. 7A is an explanatory view showing an example of an A-phase+differentiating circuit.

FIG. 7B is an explanatory view showing an example of an A-phase−differentiating circuit.

FIGS. 8A and 8B are explanatory views showing a structure of an electric angle detection circuit 760.

FIG. 9A is an explanatory view showing an example of a triangular wave generation circuit.

FIG. 9B is an explanatory view showing an example of a triangular wave generation circuit.

FIG. 10 is an explanatory view showing an example of an AD conversion circuit 770.

FIG. 11 is an explanatory view showing an example of an electric angle map 782 which is retrieved by a CPU 781.

FIG. 12 is an explanatory view showing a timing chart of respective signals in the electric angle detection circuit.

FIG. 13 is a timing chart in the present point detection circuit.

FIG. 14 is an explanatory view showing an operation flowchart of a robot.

FIG. 15 is an explanatory view showing a timing chart of respective signals in an electric angle detection circuit of a second embodiment.

### DESCRIPTION OF EXEMPLARY EMBODIMENTS

### First Embodiment

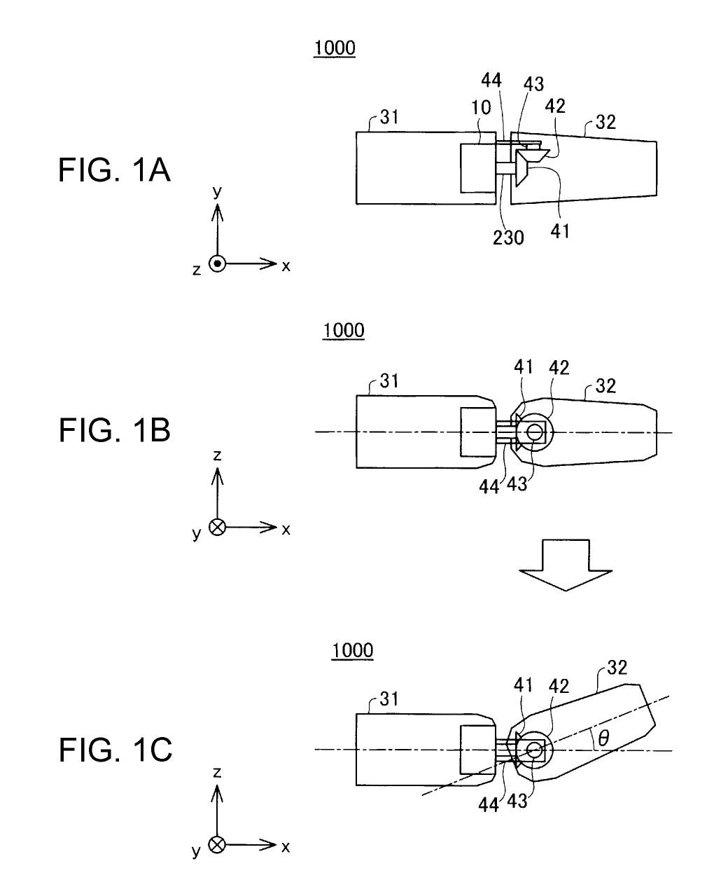

FIGS. 1A to 1C are explanatory views showing a structure of a robot arm of a first embodiment. FIG. 1A is a view in which a robot arm 1000 is seen in the z direction indicated in the drawing, FIG. 1B is a view in which the robot arm 1000 is seen in the y direction indicated in the drawing, and FIG. 1C is a view in which a state where the robot arm is bent is seen in the y direction. The robot arm 1000 includes a base part 31, a moving part 32, a motor 10, bevel gears 41 and 42, and a bevel gear support plate 44. The motor 10 is disposed at a joint part connecting the base part 31 and the moving part 32. The motor 10 includes a rotation shaft 230, and the rotation shaft 230 is connected to the bevel gear 41. The bevel gear 42 includes a rotation shaft 43. The bevel gear 42 is engaged with the bevel gear 41 and is connected to the moving part 32. The rotation shaft 43 of the bevel gear 42 is connected to the bevel gear support plate 44, and the bevel gear support plate 44 is connected to the base part 31. Although the bevel gear 42 rotates around the rotation shaft 43, the bevel gear does not move relatively to the base part 31. The rotation shaft 43 is orthogonal to the rotation shaft 230 of the motor 10. In the robot arm 1000, when the motor 10 rotates, the bevel gear 41 rotates. When the bevel gear 41 rotates, the bevel gear 42 rotates around the rotation shaft 43 by the engagement. When the bevel gear 42 rotates, the moving part 32 rotates around the rotation shaft 43 relatively to the base part 31.

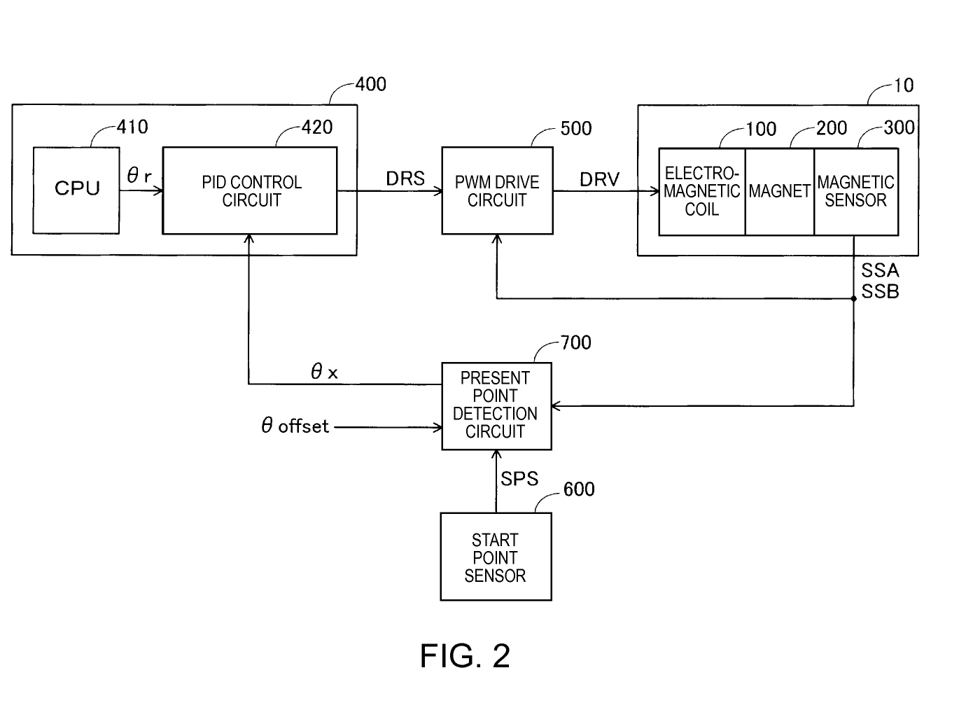

FIG. 2 is an explanatory view showing a structure of a motor system of a robot. The motor system includes the motor 10, a control part 400, a PWM drive circuit 500, a present point detection circuit 700 and a start point sensor 600. The motor 10 includes an electromagnetic coil 100, a rotor magnet 200, and a magnetic sensor 300. When a periodic AC current is applied to the electromagnetic coil 100, the rotor magnet 200 moves (rotation movement), rotates the rotation shaft 230 (FIG. 1A), and rotates the moving part 32 of the robot arm 1000. The two magnetic sensors 300 are provided, and output sensor signals SSA and SSB as analog signals corresponding to the amount of magnetic flux density from the rotor magnet 200. Incidentally, values of the sensor signals SSA and SSB are signals in which an electric angle 2π is a period. As the magnetic sensor 300, for example, a hole sensor can be used. The magnetic sensor 300 may have a temperature compensation function. The start point sensor 600 is arranged at the robot arm 1000, and generates a start point detection signal SPS. The start point detection signal is a pulse signal generated when the robot arm 1000 is positioned at the start point position.

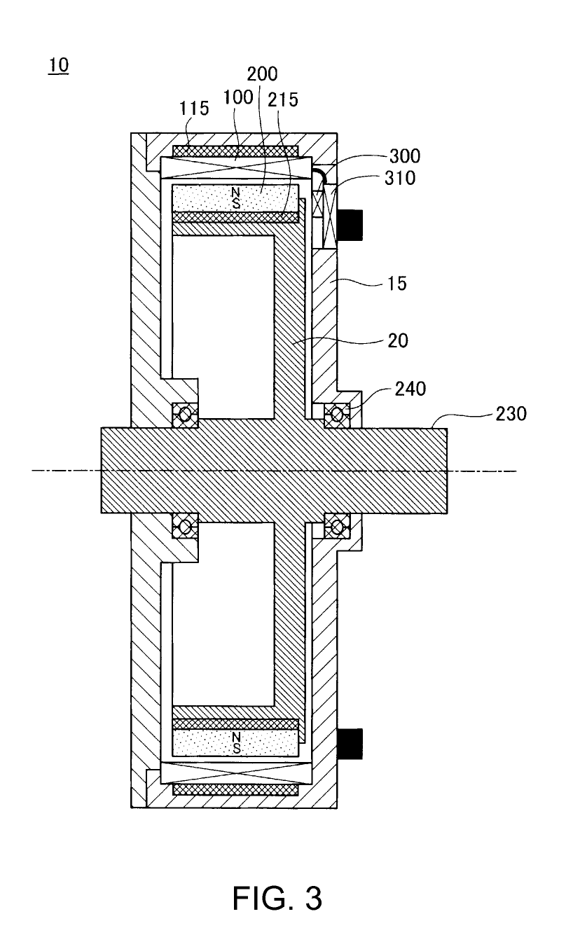

FIG. 3 is an explanatory view for explaining the motor in detail. The motor 10 includes a stator 15 and a rotor 20. The rotor 20 includes the rotation shaft 230, the rotor magnet 200 and a magnet back yoke 215. The rotation shaft 230 is positioned at the center of the rotor 20. The plural rotor magnets 200 are provided and are arranged along a circumference of a concentric cylinder around the rotation shaft 230. The direction of magnetization of the rotor magnet 200 is a radiation direction from the center of the rotation shaft 230. In the rotor magnets 200, a rotor magnet in which the magnetic flux is directed to the center direction and a rotor magnet in which the magnetic flux is directed to the outside direction are alternately arranged along the circumference. The magnet back yoke 215 is arranged on the rotation shaft 230 side of the rotor magnet 200. Incidentally, the magnet back yoke 215 may not be provided.

The stator 15 includes the electromagnetic coil 100, a coil back yoke 115, the magnetic sensor 300 and a circuit board 310. The electromagnetic coil 100 is arranged into a cylindrical shape so as to face the rotor magnet 200. In this embodiment, the two-phase electromagnetic coil 100 is provided. The coil back yoke 115 is arranged opposite the rotor magnet 200 across the electromagnetic coil 100. The stator 15 includes the two magnetic sensors 300 correspondingly to the respective phases of the electromagnetic coil 100. The two magnetic sensors 300 generate sensor signals SSA and SSB having a period of 2π in electric angle. The magnetic sensors are arranged so that the phases of the sensor signals SSA and SSB are shifted from each other by π/2. The sensor signals SSA and SSB are used to generate a control signal for driving the electromagnetic coil 100.

Incidentally, the electromagnetic coil 100 may not be two-phase, but may be single-phase or three-phase. When the electromagnetic coil 100 is single-phase, the number of the magnetic sensors 300 is one. However, when there is only the one magnetic sensor 300, detection of a rotation direction is difficult. Thus, even when the electromagnetic coil 100 is single-phase, it is preferable that the stator 15 includes two magnetic sensors 300. In this case, the two magnetic sensors are preferably arranged so that the phases of the two sensor signals are shifted from each other by π/2. Besides, when the electromagnetic coil 100 is three-phase, three magnetic sensors 300 are required correspondingly to the respective phases. However, the stator 15 may be constructed to include only two magnetic sensors 300 corresponding to two phases of the three-phase electromagnetic coil 100. This is because, in the case of the three phases, from outputs of the two magnetic sensors 300, output of the remaining one magnetic sensor 300 can be calculated by an arithmetic operation.

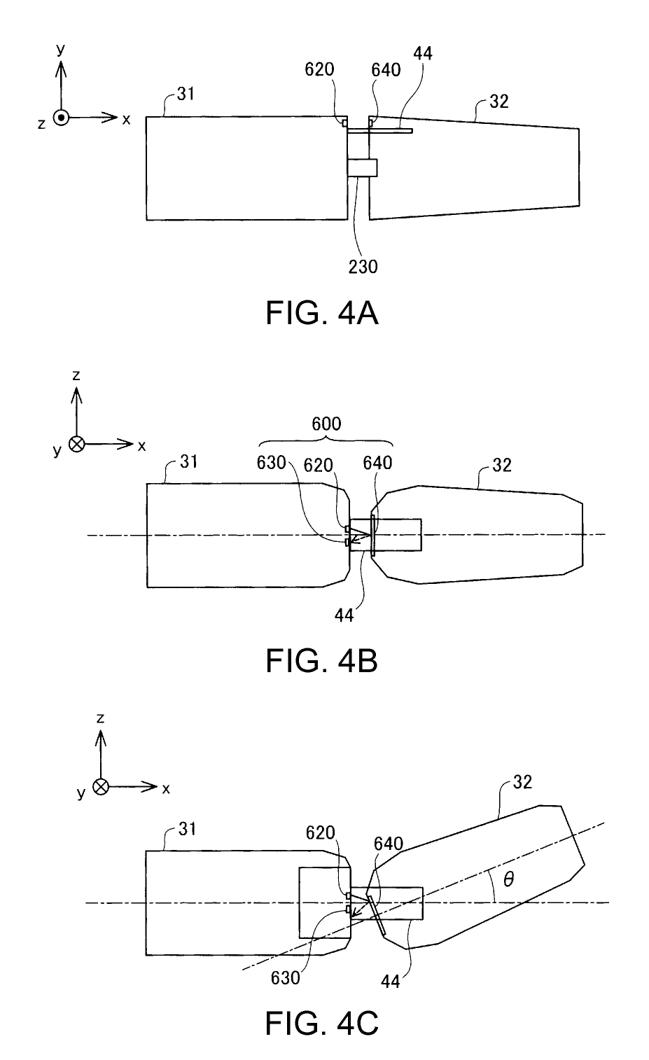

FIG. 4A is an explanatory view showing a structure of a start point sensor when the robot arm is seen in the z direction. FIG. 4B is an explanatory view when the robot arm is seen in the y direction at the start point position. FIG. 4C is an explanatory view when the robot arm is seen in the y direction at a position separate from the start point. The robot arm 1000 includes a start point sensor 600. The start point sensor 600 includes a light-emitting part 620, a light-receiving part 630 and a reflecting plate 640. Incidentally, in FIGS. 4A to 4C, since the drawing becomes complicated, the motor 10, the bevel gears 41 and 42 and the rotation shafts 230 and 43 shown in FIGS. 1A to 1C are omitted. The light-emitting part 620 and the light-receiving part 630 are disposed on the base part 31, and the reflecting plate 640 is disposed on the moving part 32. Incidentally, in FIG. 4A, since the light-receiving part 630 is concealed by the light-emitting part 620, it is not seen. Besides, in this embodiment, a state in which the base part 31 and the moving part 32 are aligned is the start point.

At the start point, as shown in FIG. 4B, the light irradiated from the light-emitting part 620 is reflected by the reflecting plate 640, and is irradiated to the light-receiving part 630. The light-receiving part 630 causes the start point detection signal SPS to be H. On the other hand, when the motor 10 (FIGS. 1A to 1C) is driven and the moving part 32 rotates from the start point, as shown in FIG. 4C, the light irradiated from the light-emitting part 620 and reflected by the reflecting plate 640 does not impinge on the light-receiving part 630. Accordingly, the light-receiving part 630 can not receive the reflected light, and the start point detection signal SPS does not become H.

The present point detection circuit 700 of FIG. 2 detects the present point of the rotor magnet 200. The present point detection circuit 700 uses the sensor signals SSA and SSB from the magnetic sensors 300, the start point detection signal SPS from the start point sensor, and the offset θoffset, and calculates present point information θx of the rotor magnet 200. Here, the offset θoffset is a difference between a phase at which the sensor signal SSB first becomes minimum after movement of the rotor magnet 200 (phase in an area where the sensor signal SSA increases and becomes VDD/2) and a phase at which the start point detection signal SPS is generated. Incidentally, when the phase at which the sensor signal SSB first becomes minimum is made to coincide with the phase at which the start point detection signal SPS is generated, the offset θoffset can be made zero.

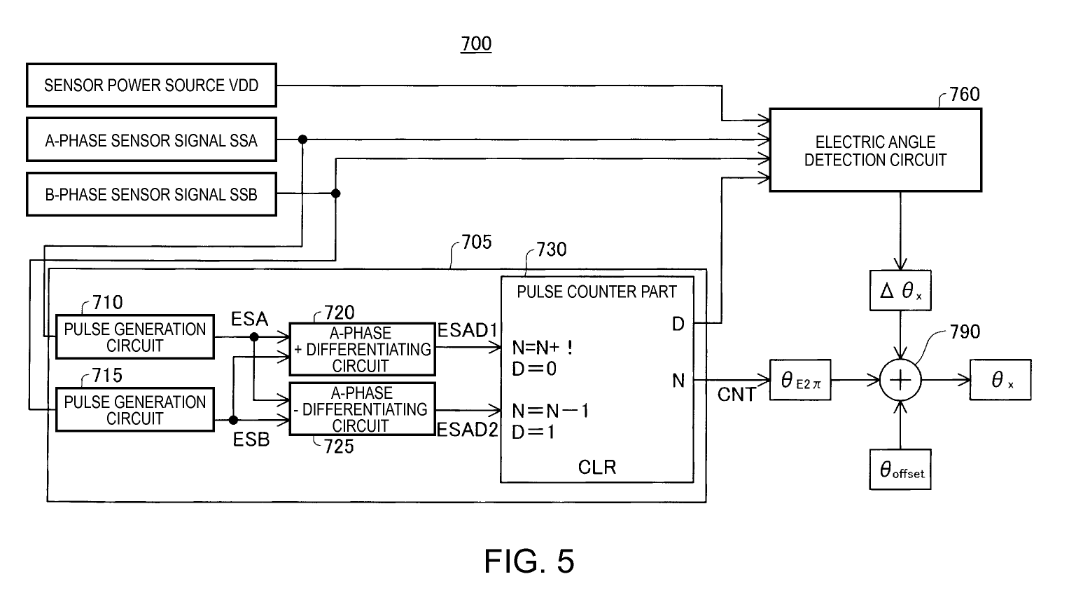

FIG. 5 is an explanatory view showing a structure of the present point detection circuit 700. The present point detection circuit 700 includes a 2π count circuit 705, an electric angle detection circuit 760 and a synthetic circuit 790. The sensor signals SSA and SSB are output signals having a period of electric angle 2π as stated above. The 2π count circuit 705 counts the number of the periods of the electric angle 2π from the start point, and calculates a first movement amount θE2π based on this count value. When the number of the periods of the electric angle 2π is CNT, θE2π=2π×CNT is established. The electric angle detection circuit 760 calculates a second movement amount Δθx (0≦Δθx<2π) from a phase at which the sensor signal SSB becomes minimum to the present point. The synthetic circuit 790 adds the first movement amount θE2π, the second movement amount Δθx and the offset θoffset, and calculates the movement amount (rotation amount) of the rotor magnet 200 from the start point.

The 2π count circuit 705 includes pulse generation circuits 710 and 715, an A-phase+differentiating circuit 720, an A-phase−differentiating circuit 725, and a pulse counter circuit 730. The pulse generation circuits 710 and 715 are so-called AD conversion circuits. A determination value is used as a threshold, and the pulse generation circuits output H when values of the sensor signals SSA and SSB are not less than the determination value, and output L when the values are less than the determination value. Incidentally, the determination value is preferably set to such a value that the period of H and the period of L become equal to each other.

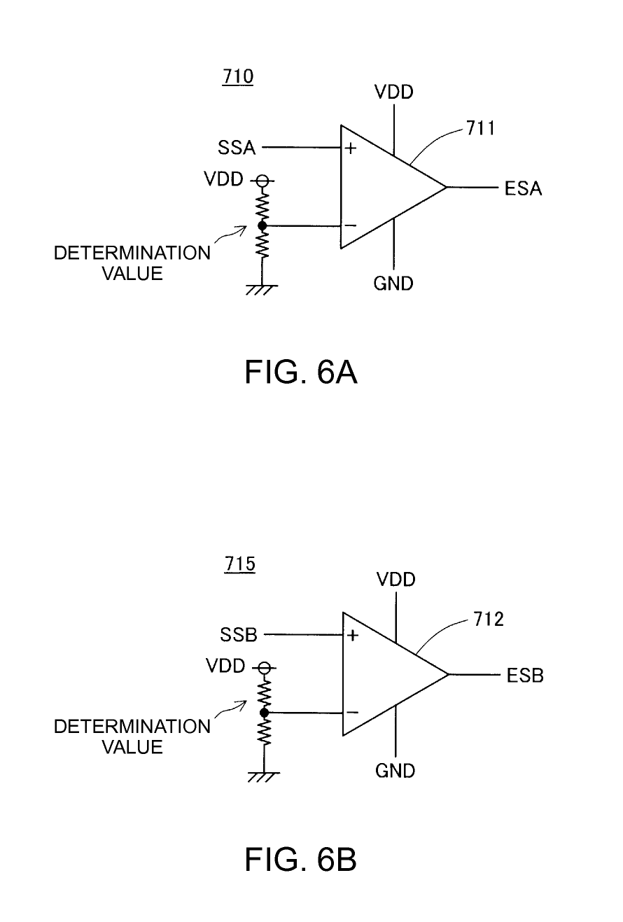

FIG. 6A shows the pulse generation circuit 710, and FIG. 6B shows the pulse generation circuit 715. Since the pulse generation circuits 710 and 715 are the same circuit except for an input signal, a description will be made while using the pulse generation circuit 710. The pulse generation circuit 710 includes an operational amplifier circuit 711. The sensor signal SSA is inputted to one input of the operational amplifier circuit, and the determination voltage (determination value) set by resistance division is inputted to the other input. When the sensor signal SSA is not less than the determination voltage, an output ESA of the operational amplifier circuit 711 becomes H, and when the sensor signal SSA is less than the determination voltage, the output EAS of the operational amplifier circuit 711 becomes L.

The A-phase+differentiating circuit 720 of FIG. 5 is the circuit to generate a pulse when the rotor 20 (FIG. 2) rotates in a normal direction. The A-phase−differentiating circuit 725 is the circuit to generate a pulse when the rotor 20 rotates in a reverse direction.

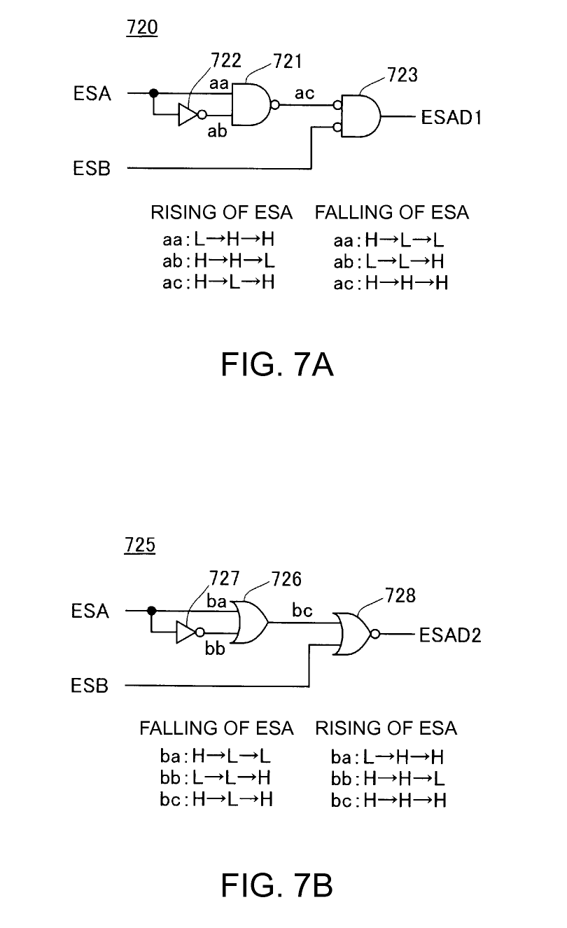

FIG. 7A is an explanatory view showing an example of the A-phase+differentiating circuit. The A-phase+differentiating circuit 720 includes a NAND circuit 721, an inverter circuit 722, and a NOR circuit 723. The output ESA of the pulse generation circuit 710 (FIG. 6A) is inputted to one input aa of two inputs of the NAND circuit 721. Besides, the output ESA is inputted to the inverter circuit 722, and the output of the inverter circuit 722 is inputted to the other input ab of the two inputs of the NAND circuit 721. An output ac of the NAND circuit 721 and an output ESB of the pulse generation circuit 715 (FIG. 6B) are inputted to two inputs of the NOR circuit 723. The output of the NOR circuit 723 is an addition signal ESAD1.

In a state where the output ESA does not transition, the inputs aa and ab of the NAND circuit 721 are related such that one of them is H, the other is L, and accordingly, the output ac of the NAND circuit 721 is H. Consideration will be given to a state where the output ESA transitions. When the output ESA transitions from L to H, the input aa of the NAND circuit 721 transitions from L to H. On the other hand, the input ab of the NAND circuit 721 transitions from H to L. At this time, since the inverter circuit 722 exists, the input ab of the NAND circuit 721 transitions slightly later than the change of the input aa of the NAND circuit 721. As a result, a period when both the inputs aa and ab of the NAND circuit 721 become H occurs in a moment, and the output ac of the NAND circuit 721 becomes L in a moment. At this time, when the output ESB is L, the addition signal ESAD1 becomes H in a moment. Incidentally, when the output ESB is L, even if the output ac of the NAND circuit 721 becomes L in a moment, the addition signal ESAD1 remains L. On the other hand, when the output ESA transitions from H to L, the input aa of the NAND circuit 721 transitions from H to L, and the input ab of the NAND circuit 721 transitions from L to H slightly late. At this time, since a period when both the inputs aa and ab of the NAND circuit 721 become H does not occur, the output ac of the NAND circuit 721 does not become L. Accordingly, the addition signal ESAD1 remains L. That is, when the output ESB is L and the output ESA transitions from L to H, the A-phase+differentiating circuit 720 causes the H pulse to be generated in the addition signal ESAD1.

FIG. 7B is an explanatory view showing an example of the A-phase−differentiating circuit. Although the A-phase+differentiating circuit 720 includes the NAND circuit 721, the A-phase−differentiating circuit 725 is different in that an OR circuit 726 is provided instead of the NAND circuit 721. The output of the A-phase−differentiating circuit 725 is a subtraction signal ESAD2. In this OR circuit 726, when the output ESA transitions from H to L, an input ba transitions from H to L, and an input bb transitions from L to H slightly late. At this time, since a period when both the inputs ba and bb of the OR circuit 726 become L occurs in a moment, an output bc of the OR circuit 726 becomes L in a moment. At this time, when the output ESB is L, the subtraction signal ESAD2 becomes H in a moment. Incidentally, when the output ESB is L, even if the output bc of the OR circuit 726 becomes L in a moment, the subtraction signal ESAD2 remains L. On the other hand, when the output ESA transitions from L to H, since a period when both the inputs ba and bb of the OR circuit 726 become L does not occur, the output bc of the OR circuit 726 does not become L. Accordingly, the subtraction signal ESAD2 remains L. That is, when the output ESB is L and the output ESA transitions from H to L, the A-phase−differentiating circuit 725 causes the H pulse to be generated in the subtraction signal ESAD2. According to whether the H pulse is generated in the addition signal ESAD1 or whether the H pulse is generated in the subtraction signal ESAD2, it is possible to determine whether the rotation direction of the rotor 20 (FIG. 3) is the normal direction or the reverse direction. Incidentally, it is preferable that the phase at which the H pulse is generated in the addition signal ESAD1 at the time of the normal rotation is the same as the phase at which the H pulse is generated in the subtraction signal ESAD2 at the time of the reverse direction. This is because, since the addition signal ESAD1 or the subtraction signal ESAD2 is used to increment or decrement the counter value CNT of the pulse counter circuit 730 described below, when the phases are shifted from each other, timings when the counter value CNT is incremented and decremented become different from each other.

The pulse counter circuit 730 of FIG. 5 increments the counter value CNT by one when the H pulse is generated in the addition signal ESAD1, and decrements the counter value CNT by one when the H pulse is generated in the subtraction signal ESAD2. Incidentally, in relation to the sensor signals SSA and SSB, the timing when the counter value CNT changes is the phase when the sensor signal SSB becomes minimum. The counter value CNT corresponds to the number of the electric angle 2π of the sensor signal SSA (SSB) from the start point. For example, when the counter value CNT is m, the present point is located at a position separated from the start point by (2π×m+Δθx+θoffset). Here, the electric angle Δθx (0≦Δθx<2π) indicates the movement amount (rotation amount) of the rotor 20 (FIG. 3) to the present point from the position where the present counter value m is obtained when the counter value CNT increments. Next, the electric angle detection circuit 760 to calculate the electric angle Δθx will be described.

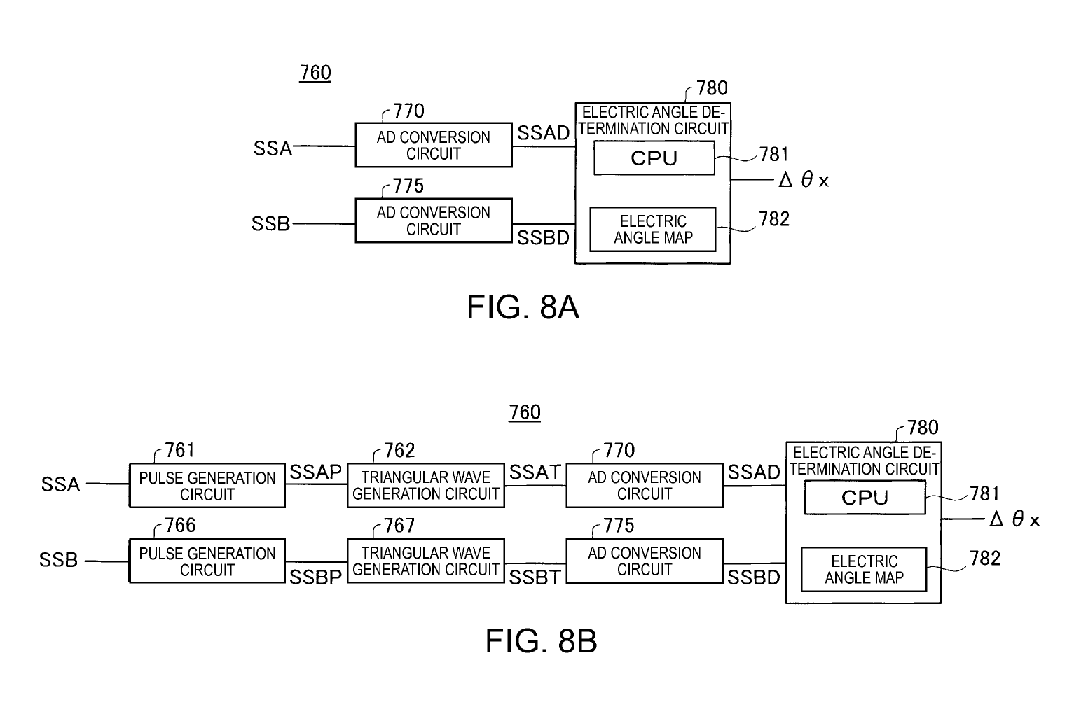

FIGS. 8A and 8B are explanatory views showing a structure of the electric angle detection circuit 760. Here, FIG. 8A shows a circuit example in a case where the sensor signal SSA, SSB has an unsaturated waveform such as a sine wave, and FIG. 8B shows a circuit example applicable also to a case where the sensor signal SSA, SSB is saturated. The electric angle detection circuit 760 shown in FIG. 8A includes AD conversion circuits 770 and 775 and an electric angle determination circuit 780, and the sensor signals SSA and SSB are directly inputted to the AD conversion circuits 770 and 775. On the other hand, the electric angle detection circuit 760 shown in FIG. 8B is different in that pulse generation circuits 761 and 766 and triangular wave generation circuits 762 and 767 are provided at the previous stage of the AD conversion circuits 770 and 775 of the electric angle detection circuit 760 shown in FIG. 8A. Specifically, although described later, in the case where the sensor signals SSA and SSB are saturated, when the sensor signals SSA and SSB are directly inputted to the AD conversion circuits 770 and 775, there are plural electric angles corresponding to the same digital value SSAD, SSBD, and there can be a case where the electric angle can not be uniquely determined. Thus, the pulse generation circuits 761 and 766 and the triangular wave generation circuits 762 and 767 are provided. Hereinafter, a description will be made while using the electric angle determination circuit 760 of FIG. 8B as an example.

The pulse generation circuits 761 and 766 convert the sensor signals SSA and SSB into pulse wave signals SSAP and SSBP. The triangular wave generation circuits 762 and 767 convert the pulse wave signals SSAP and SSBP into triangular wave signals SSAT and SSBT. The AD conversion circuits 770 and 775 AD-convert the triangular wave signals SSAT and SSBT and generate digital signals SSAD and SSBD. The electric angle determination circuit 780 includes a CPU 781 and an electric angle map 782. The CPU 781 uses the digital signals SSAD and SSBD to retrieve the electric angle map 782, and acquires the electric angle Δθx. Incidentally, since the triangular wave is linear, the CPU 781 may calculate Δθx by an arithmetic operation from the digital signals SSAD and SSBD.

The pulse generation circuits 761 and 766 may have the same structure as the pulse generation circuits 710 and 715 explained in FIG. 6A and FIG. 6B. Accordingly, the pulse generation circuits 710 and 715 are used instead of the pulse generation circuits 761 and 766, and the outputs of the pulse generation circuits 710 and 715 may be made the inputs of the triangular wave generation circuits 762 and 767.

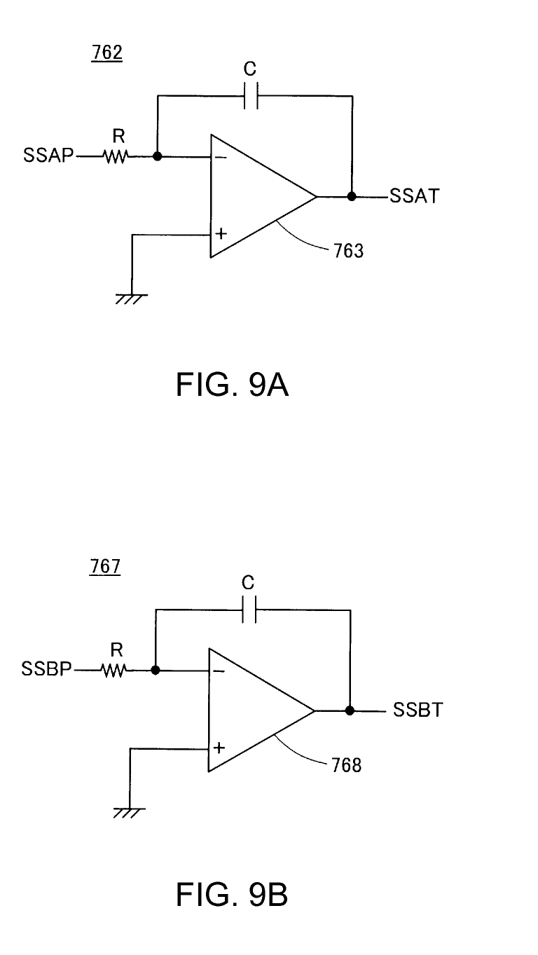

FIG. 9A and FIG. 9B are explanatory views showing an example of the triangular wave generation circuit. As the triangular wave generation circuits 762 and 767, an integrating circuit can be used. Since the triangular wave generation circuits 762 and 767 are the same circuit, a description will be made while using the triangular wave generation circuit 767 as an example. The triangular wave generation circuit 762 includes an operational amplifier 763, a resistor R and a capacitor C. The output signal SSAP of the pulse generation circuit 761 is inputted to one input (−) of the triangular wave generation circuit 762 through the resistor R. The ground potential is inputted to the other input (+) of the triangular wave generation circuit 762. The output signal SSAT (triangular wave signal SSAT) as the output of the triangular wave generation circuit is connected to the one input (−) of the triangular wave generation circuit 762 through the capacitor C. In this structure, when the potential of the pulse wave signal SSAP is V_{SSAP}, the potential V_{SSAT} of the output signal SSAT of the triangular wave generation circuit is expressed by the following expressions (1) and (2).

$$\begin{matrix}\begin{matrix}{V}_{SSAT} = \frac{1}{R \times C} \int {V}_{SSAP} d t & ( {V}_{SSAP} = H = VDD )\end{matrix} & ( 1 ) \\ \begin{matrix}{V}_{SSAT} = VDD - \frac{1}{R \times C} \int {V}_{SSAP} d t & ( {V}_{SSAP} = L = 0 )\end{matrix} & ( 2 )\end{matrix}$$

Since the potential V_{SSAP} is a binary of H and L, the potential V_{SSAT} has a triangular wave shape.

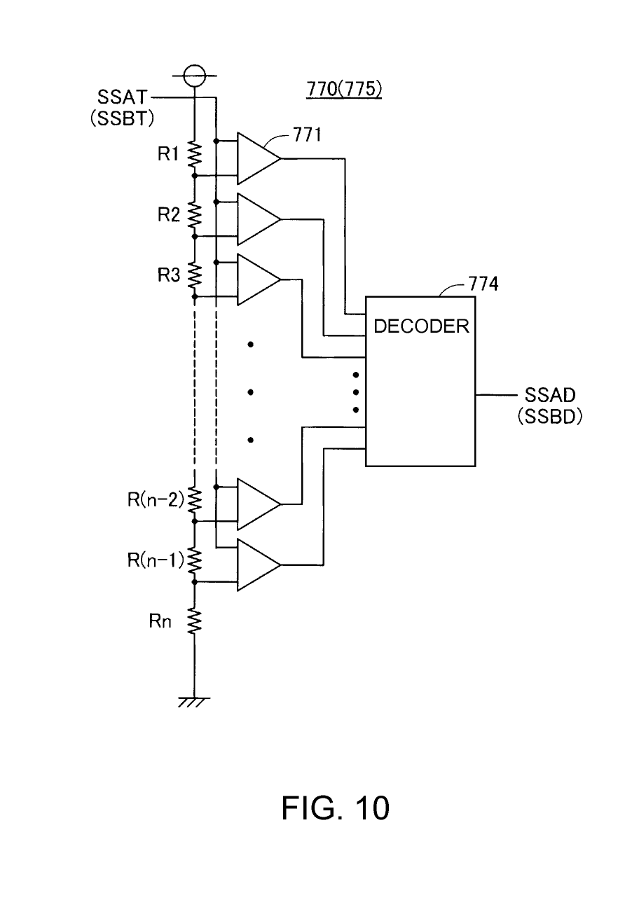

FIG. 10 is an explanatory view showing an example of the AD conversion circuit 770. The AD conversion circuit 770 includes n (n is a natural number of 2 or larger) resistors R1 to Rn connected in series, (n−1) comparators 771, and a decoder 774. The resistors R1 to Rn have the same resistance value and divide voltage VDD by n. Each of (n−1) connection points between the respective resistors is inputted to one input of each of the comparators 771. The triangular wave signal SSAT as the output of the triangular wave generation circuit is inputted to the other input of each of the comparators 771. The comparator 771 compares a potential (called “determination potential”) at the connection point between the resistors with the potential of the triangular wave signal SSAT, and outputs H when the potential of the triangular wave signal SSAT is not lower than the determination potential, and outputs L when the potential of the triangular wave signal SSAT is lower than the determination potential. The outputs of the respective comparators 771 are inputted to the decoder 774. The decoder 774 combines these, and outputs the m-bit digital signal SSAD. Incidentally, the comparators 771 and the resistors depend on the number of output bits of the digital signal SSAD. For example, when the digital signal SSAD has 10 bits, 1024 comparators 771 are required, and 1025 resistors are required. The AD converter 775 has the same structure as the AD converter 770, and the output signal SSBT is inputted and the digital signal SSBD is outputted.

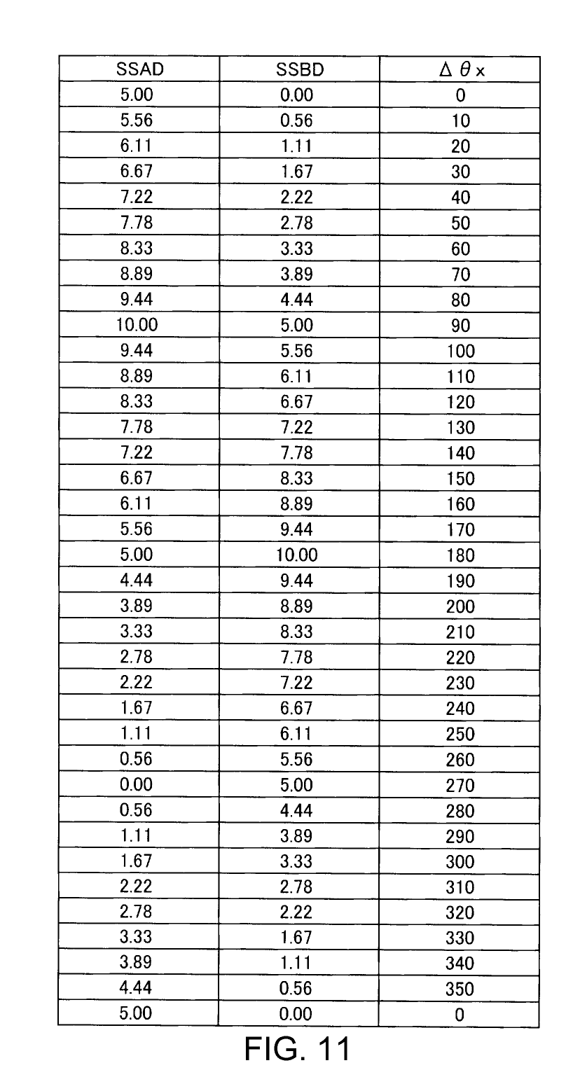

FIG. 11 is an explanatory view showing an example of the electric angle map 782 which is retrieved by the CPU 781. Here, the maximum value of the digital signals SSAD and SSBD is 10 V, and the minimum value is 0 V. When the values of the digital signals SSAD and SSBD are determined, the CPU 781 retrieves the electric angle map 782 and can easily acquire the electric angle Δθx. For example, when the value of the SSAD is 6.67, two values of 30° and 150° are conceivable as the value of the electric angle Δθx. However, when the SSBD is 1.67, the electric angle Δθx is uniquely determined to be 30°, and when the SSBD is 8.33, the electric angle Δθx is uniquely determined to be 150°.

Incidentally, in FIG. 8B, the reason why the pulse wave signals SSAP and SSBP are generated from the sensor signals SSA and SSB, the triangular wave signals SSAT and SSBT are generated from the pulse wave signals SSAP and SSBP, and the digital signals SSAD and SSBD are generated from the triangular wave signals SSAT and SSBT is as described below. That is, the sensor signals SSA and SSB outputted by the magnetic sensors 300 are not necessarily signals obtained by shifting sine waves, and according to the positions of the magnetic sensors 300, there is a case where the sensor signals SSA and SSB are saturated at the maximum portion or become almost zero at the minimum portion (hereinafter called “subjected to saturation or the like”). When the sensor signals SSA and SSB are not subjected to saturation or the like, the value of the sensor signal and the electric angle correspond to each other at a ratio of 1 to 2 except for the maximum point and the minimum point. Incidentally, at the maximum point, the ratio is 1 to 1. Accordingly, when the values of the sensor signals SSA and SSB are known, the electric angle can be obtained. However, when the sensor signals SSA and SSB are subjected to saturation or the like, since the value of the sensor signal SSA, SSB and the electric angle correspond to each other at a ratio of 1 to m (m is a value exceeding 2), there can be a case where the electric angle can not be uniquely determined. Even if the sensor signals SSA and SSB are subjected to saturation or the like as stated above, when the conversion is performed as shown in FIG. 8B, the electric angle Δθx can be easily obtained.

In this embodiment, the triangular wave generation circuits 762 and 767 are used, and the triangular wave signals SSAT and SSBT are generated from the output signals SSAP and SSBP. However, sine converter circuits are used instead of the triangular wave generation circuits 762 and 767, sine wave signals SSAS and SSBS are generated instead of the triangular waves, and an electric angle map corresponding to the values of the sine waves may be used.

Incidentally, when the magnetic sensors 300 are arranged so that the sensor signals SSA and SSB are not saturated, as shown in FIG. 8A, the sensor signals SSA and SSB are directly inputted to the AD conversion circuits 770 and 775, and the digital signals SSAD and SSBD may be generated. In this case, the electric angle map 772 is the map showing the relation between the digital signals SSAD and SSBD and the electric angle Δθx.

Besides, in general, since the circuit scale of the AD conversion circuit becomes large, the triangular wave generation circuit 767 for the B phase and the AD converter 775 may not be provided. In that case, except for the maximum point and the minimum point of the sensor signal SSA, values of two phases are conceivable for the value of the digital signal SSAD. In this case, a determination can be made on which of the phases is to be adopted according to whether the output signal SSBP of the pulse generation circuit 766 is H or L. Incidentally, it is preferable that the phases of the sensor signals SSA and SSB are shifted from each other by π/2 in electric angle.

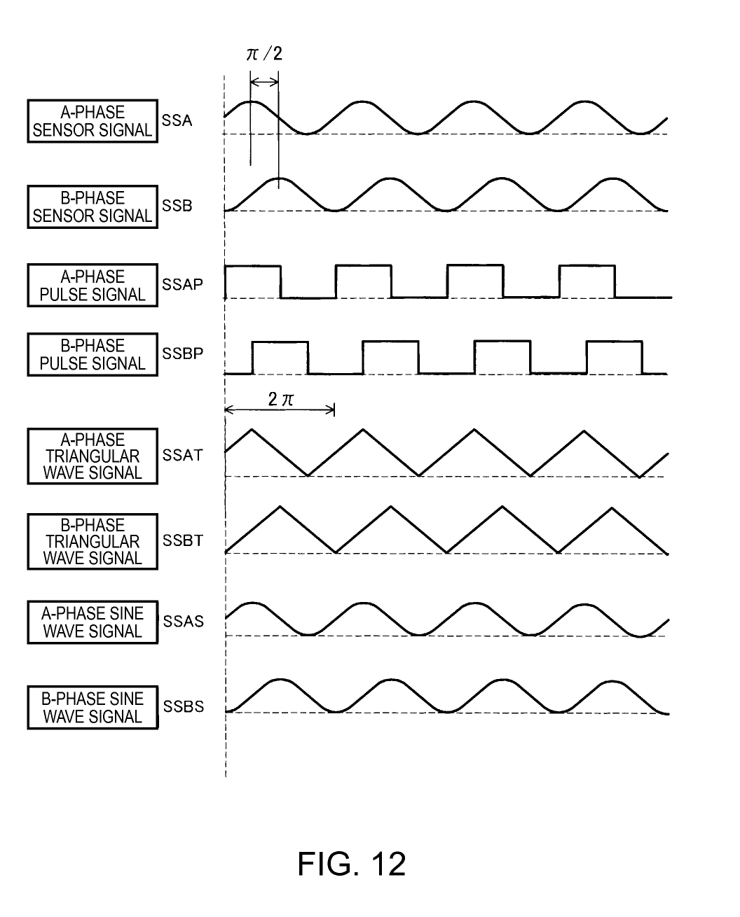

FIG. 12 is an explanatory view showing a timing chart of respective signals in the electric angle detection circuit. Here, the sine wave signals SSAS and SSBS are shown in addition to the triangular wave signals SSAT and SSBT.

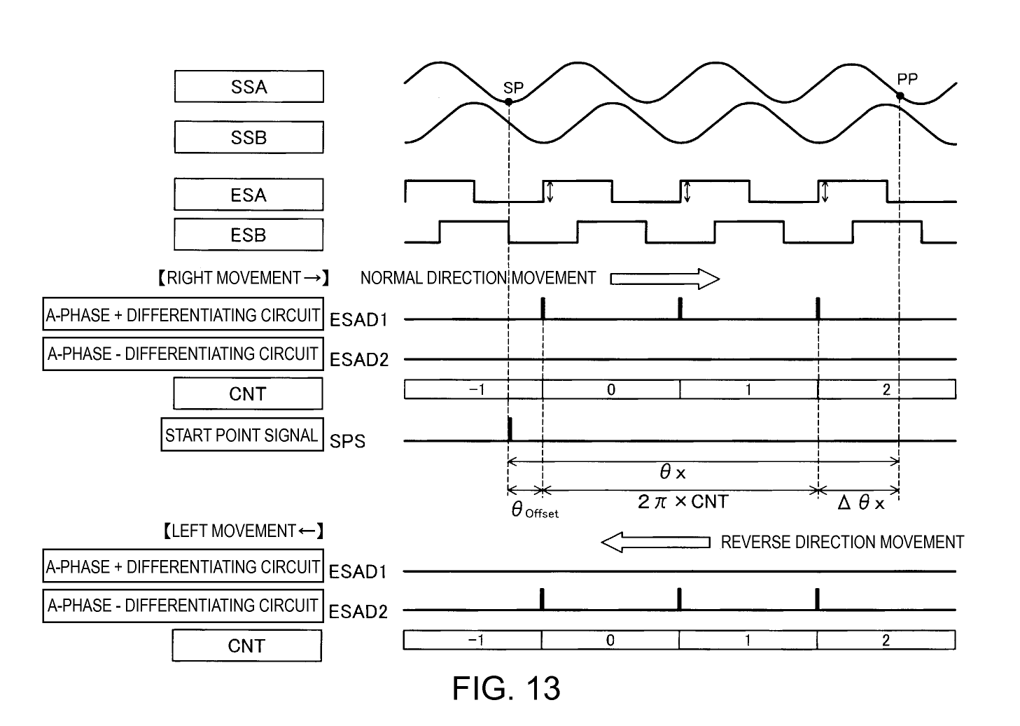

FIG. 13 is a timing chart in the present point detection circuit. Here, SP shown in the drawing designates a start point, and PP designates a present point. An offset θoffset represents a phase until the addition signal ESAD1 first becomes H after the motor 10 rotates in the normal direction and the start point detection signal SPS becomes H. In this embodiment, the pulse count circuit 730 (FIG. 5) is set so that when the addition signal ESAD1 first becomes H, the counter value CNT becomes 0. The motor 10 rotates in the normal direction and each time the addition signal ESAD1 becomes H, the pulse counter circuit 730 increments the counter value CNT by one. In the example of FIG. 13, at the present point PP, the counter value CNT is 2. The phase (electric angle Δθx) from the point when the third addition signal ESAD1 becomes H to the present point PP can be calculated as described in FIGS. 8A to FIG. 10. Accordingly, the movement amount (rotation amount) Δθ from the start point SP to the present point PP can be obtained by θoffset+2π×CNT+Δθx. Incidentally, when the motor rotates in the reverse direction, the counter value CNT is decremented by one by the subtraction signal ESAD2.

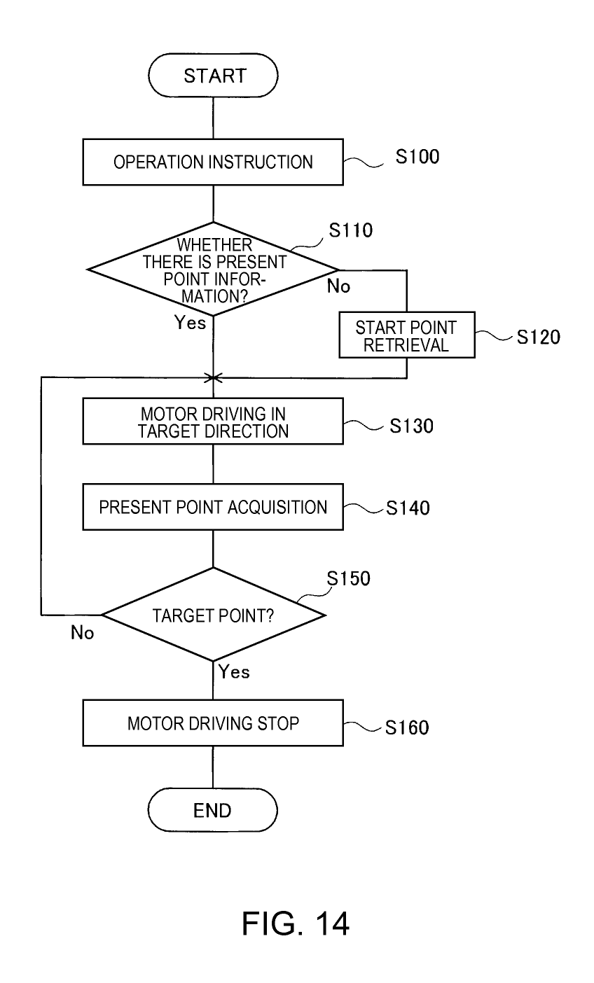

FIG. 14 is an explanatory view showing an operation flowchart of the robot arm. At step S100 of FIG. 14, when the robot arm 1000 receives an operation instruction to a target point (position information of the target point is called “target point information θr”), the control part 400 (FIG. 2) shifts the process to step S110, and determines whether there is a phase θx (hereinafter sometimes called “present point information θx”) of the present point of the motor 10. Here, the present point information θx is the information indicating how much the motor 10 is rotated with respect to the start point (reference point), and is the information indicating how much the moving part 32 is rotated with respect to the base part 31. Here, although the present point information θx is indicated by θx=θoffset+2π×CNT+Δθx, among these, the offset θoffset is already known at the design stage of the motor 10, and the control part 400 can easily acquire the electric angle Δθx from the present sensor outputs SSA and SSB. Accordingly, when the counter value CNT is known, the control part 400 can know the present point information θx. Incidentally, since the present point information θx is the value expressed in the electric angle of the motor 10, the control part 400 converts the present point information θx into a mechanical angle, and calculates a movement angle of the moving part 32 from the start point. Incidentally, the start point detection circuit 700 performs calculation using the mechanical angle CNT×θ0 instead of 2π×CNT, and the electric angle map 782 may be constructed so that the mechanical angle, instead of the electric angle, is calculated.

When the control part 400 does not have the present point information θx of the motor 10, the control part shifts the process to step S120, rotates the motor 10 in the normal direction or the reverse direction, and retrieves the start point SP of the motor 10. The start point SP is the point where the start point detection signal SPS becomes H, and is the point which becomes the basis for the operation of the robot arm 1000. Incidentally, the state of the base part 31 and the moving part 32 at the start point SP can be variously determined according to the design of the robot arm 1000. For example, as the start point SP, a state where the base part 31 and the moving part 32 are aligned may be made the start point SP. Besides, a state where the moving part 32 is rotated to be most separated from the linear state with respect to the base part 31 may be made the start point SP.

At step S130, the control part 400 drives the motor 10 to move in the target direction while the present point information θx or the position of the start point SP is made the reference. When θr−θx obtained by subtracting the present point information θx from the target point information θr is larger than 0, the control part 400 drives the motor 10 in the normal direction, and when θr−θx is smaller than 0, the control part drives the motor in the reverse direction. The control part 400 sends a drive signal DRS for causing the movement in the target direction to the PWM drive circuit 500 (FIG. 2). The PWM drive circuit 500 uses the drive signal DRV and drives the electromagnetic coil 100.

The control part 400 drives the motor 10, and at step S140, acquires the present point information θx of the rotor 20. The control part 400 compares the target point information θr with the present point information θx. When the control part 400 detects that θr=θx is established and the rotor 20 of the motor 10 reaches the target point (step S150), the control part shifts the process to step S160, and causes the PWM drive circuit 500 to stop the driving of the motor 10.

Since the first embodiment includes the start point sensor to generate the start point detection signal SPS and the present point detection circuit 700 to calculate the present point information θx by using the sensor signals SSA and SSB, even if an encoder is not provided, the present point is easily acquired, and the motor 10 can be driven and controlled.

Besides, the control part can easily obtain the present point information θx from the counter value CNT from the 2π count circuit 705 (FIG. 5) and the electric angle Δθx from the electric angle detection circuit 760.

According to this embodiment, since the sensor signals SSA and SSB are shifted from each other by π/2, the electric angle can be easily acquired.

### Second Embodiment

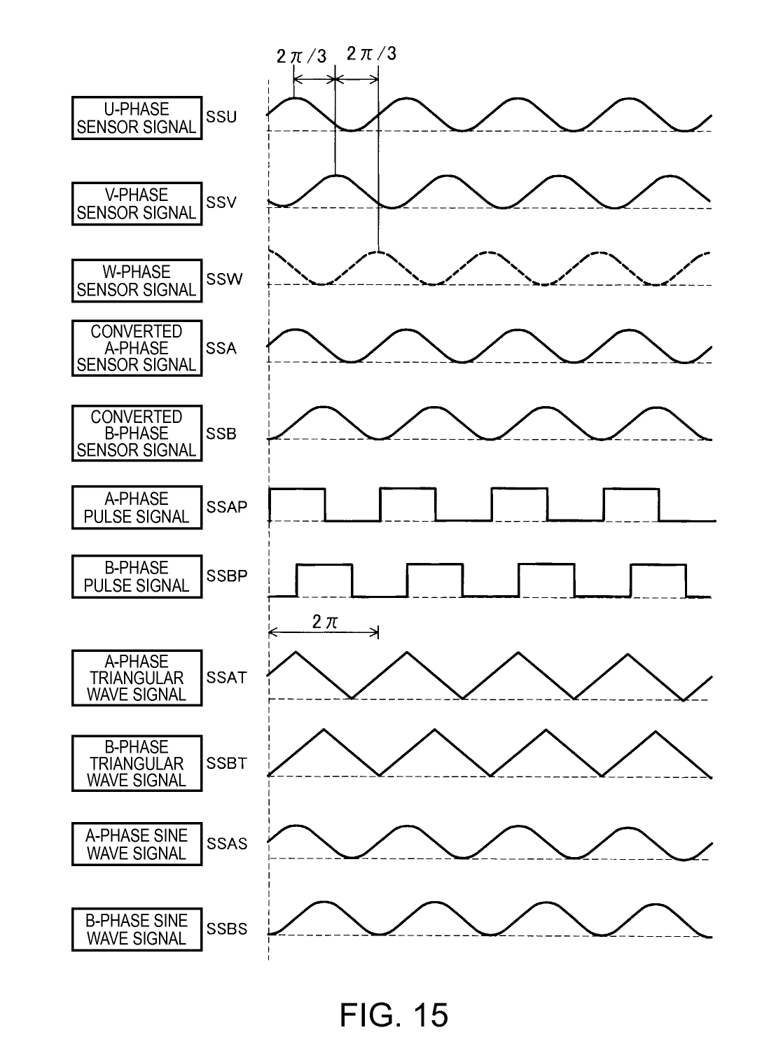

FIG. 15 is an explanatory view showing a timing chart of respective signals in an electric angle detection circuit in a second embodiment. In the first embodiment, the two-phase motor is used, while in the second embodiment, a three-phase (U-phase, V-phase, W-phase) motor is used. In the second embodiment, magnetic sensors are provided only for the U-phase and the V-phase. The magnetic sensors for the U-phase and the V-phase generate sensor signals SSU and SSV with a phase difference of 2π/3. Here, the sensor signals SSU and SSV are sine waves. When the signals are not the sine waves, as described in the first embodiment, the waveform conversion is performed, and the sine converter is finally used, so that the sine waves can be easily generated.

The sensor signal SSW shown in FIG. 15 is calculated from the sensor signals SSU and SSV. When the minimum value of the sensor signals SSU and SSV is zero, and the maximum value is VDD, SSU+SSV+SSW=(3/2)×VDD is established. Accordingly, when the sensor signals SSU and SSV are known, the remaining sensor signal SSW can be easily calculated.

Next, the three sensor signals are used, and the three phases of UVW are converted into two phases of AB. Specifically, a matrix operation indicated by the following expression (3) is performed, so that the sensor signals SSA and SSB after two-phase conversion can be calculated from the sensor signals SSU to SSW.

$$( \begin{matrix}SSA \\ SSB\end{matrix} ) = \sqrt{\frac{2}{3}} ( \begin{matrix}1 & - 1 / 2 & - 1 / 2 \\ 0 & \sqrt{3} / 2 & - \sqrt{3} / 2\end{matrix} ) ( \begin{matrix}SSU \\ SSV \\ SSW\end{matrix} ) \qquad ( 3 )$$

After the sensor outputs SSA and SSB after the two-phase conversion are calculated, the control part 400 performs the same process as the first embodiment to detect the present point of the rotor 20, and can control the motor 10 to a target point GP. As stated above, also in the three-phase motor, similarly to the two-phase motor, the control part 400 acquires the present point information θx, and can control the operation of the motor 10.

In the embodiment, although the example in which the rotation amount from the start point is obtained is described, the invention can be applied to a case where the control part 400 obtains a relative rotation amount from the present point (starting point). That is, the control part 400 can calculate the electric angle Δθx at the starting point and the present point by the foregoing method. Although the counter value CNT is unknown, the control part sets the counter value CNT2 at the present point to zero. The counter value CNT2 is incremented or decremented at the same timing as the counter value CNT. The control part 400 can easily calculate the relative movement amount by using a difference between the counter values CNT2 before and after the movement, and a difference between the electric angles Δθx before and after the movement. Incidentally, in this case, it is conceivable that a difference between Δθx and 2π at the starting point corresponds to θoffset. This θoffset represents a movement amount from the starting point to a point where the counter value CNT2 is first changed. Incidentally, at the starting point, when the sensor output signal SSA outputs an intermediate value between the minimum value and the maximum value, the θoffset can be made zero. Besides, when the starting point in the second embodiment is made the start point in the first embodiment, the relative movement amount of the rotor 20 can be made to correspond to the position of the rotor 20.

Although the embodiments of the invention are described based on the examples, the embodiments of the invention are for facilitating understanding of the invention and does not limit the invention. The invention can be modified and improved without departing from the gist and claims thereof, and the invention naturally includes the equivalents thereof.

The present application claims the priority based on Japanese Patent Application No. 2011-008761 filed on Jan. 19, 2011, the disclosures of which are hereby incorporated by reference in their entireties.

What is claimed is:

1. An electrical machine apparatus comprising:
an electromagnetic coil;
a rotor magnet;
n (n is an integer not less than 2) magnetic sensors to detect an electric angle of the rotor magnet; and
a position detection part to detect a position of the rotor magnet by using outputs of the magnetic sensors, wherein
each of the magnetic sensors generates a sensor output signal having a curved line waveform and a period of electric angle 2π of the electrical machine apparatus,
the respective n magnetic sensors are arranged to generate the sensor output signals with a phase difference other than an integer times π in electric angle, and
the position detection part calculates a movement amount of the rotor magnet from a starting point as a position before movement by using the sensor output signals of the n magnetic sensors.

2. The electrical machine apparatus according to claim 1, wherein the magnetic sensors output an amount of magnetic flux density from the rotor magnet as the sensor signals which are analog.

3. The electrical machine apparatus according to claim 1, wherein the position detection part counts a number m (m is an integer) of periods occurring in the sensor output signal of the magnetic sensor by the movement of the rotor magnet from the starting point, and calculates the movement amount of the rotor magnet by using the number m of periods, the starting point, and a magnitude of the sensor output signal after the movement.

4. The electrical machine apparatus according to claim 3, wherein the position detection part calculates an offset θoffset as a movement amount of the rotor magnet from the starting point to a first change of the number m of periods by using a magnitude of the sensor output signal at the starting point, calculates a first movement amount mθo of the rotor magnet based on the number m of periods, calculates a second movement amount Δθ of the rotor magnet after passage of the number m of periods from the magnitude of the sensor output signal after the movement, and calculates the movement amount of the rotor magnet from the starting point by using a value (mθo+Δθ) obtained by adding the first movement amount mθo and the second movement amount Δθ and the offset θoffset.

5. The electrical machine apparatus according to claim 4, wherein the position detection part converts the sensor output signal into a triangular wave signal, and calculates the second movement amount Δθ of the rotor magnet after passage of the number m of periods by using a value of the triangular wave signal.

6. The electrical machine apparatus according to claim 4, wherein the position detection part converts the sensor output signal into a sine wave signal, and calculates the second movement amount Δθ of the rotor magnet after passage of the number m of periods by using a value of the sine wave signal.

7. The electrical machine apparatus according to claim 1, wherein one magnetic sensor of the plurality magnetic sensors outputs an intermediate value between a minimum value and a maximum value of the sensor output signal at the starting point.

8. The electrical machine apparatus according to claim 1, wherein the number n of the magnetic sensors is 2, and the magnetic sensors are arranged to generate the output signals with a phase difference of π/2 in electric angle.

9. The electrical machine apparatus according to claim 1, wherein the magnetic sensors have temperature compensation functions.

10. The electrical machine apparatus according to claim 1, wherein the electrical machine apparatus is the apparatus that drives a driving target member including a start point sensor to detect a start point, and
the position detection part calculates a movement amount of the rotor magnet from the start point by using the sensor output signals from the n magnetic sensors.

11. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 1.

12. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 2.

13. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 3.

14. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 4.

15. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 5.

16. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 6.

17. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 7.

18. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 8.

19. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 9.

20. A robot comprising:
a base part;
a moving part;
a start point sensor to generate a start point signal when the base part and the moving part are located at a previously determined position; and
an electrical machine apparatus that is disposed at a joint part between the base part and the moving part and moves the moving part relatively to the base part, wherein
the electrical machine apparatus is the electrical machine apparatus according to claim 10.
